(19) United States
(12) Patent Application Publication
(10) Pub. No.: US 2025/0282373 A1
(43) Pub. Date: Sep. 11, 2025

(54) DISPLAY CONTROL DEVICE, DISPLAY CONTROL METHOD, AND NON-TRANSITORY COMPUTER-READABLE RECORDING MEDIUM

(71) Applicant: TOYOTA JIDOSHA KABUSHIKI KAISHA, Toyota-shi (JP)

(72) Inventor: Miki TSUJINO, Nagakute-shi (JP)

(73) Assignee: TOYOTA JIDOSHA KABUSHIKI KAISHA, Toyota-shi (JP)

(21) Appl. No.: 19/046,739

(22) Filed: Feb. 6, 2025

(30) Foreign Application Priority Data
Mar. 7, 2024 (JP) 2024-034871

(51) Int. Cl. B60W 50/14

(52) U.S. Cl. CPC B60W 50/14; B60W 2050/146

(57) ABSTRACT

A display control device of the present disclosure includes: a data acquisition unit configured to acquire mode information including a driving assistance mode of a vehicle and information related to deceleration assistance for decelerating the vehicle; and a display controller configured to display a driving mode image corresponding to the acquired mode information on a display device and to specify a display format of a deceleration assistance image to be displayed in relation to the deceleration assistance in a corresponding manner to a display format of the driving mode image and display the deceleration assistance image in the specified display format on the display device.

### CROSS-REFERENCE TO RELATED APPLICATION

This application claims priority to Japanese Patent Application No. 2024-034871 filed on Mar. 7, 2024. The disclosure of the above-identified application, including the specification, drawings, and claims, is incorporated by reference herein in its entirety.

### BACKGROUND

### 1. Technical Field

The present disclosure relates to a display control device, a display control method, and a non-transitory computer-readable recording medium.

### 2. Description of Related Art

In recent vehicles, a driver may not solely drive the vehicle through manual operations alone but also drive the vehicle while receiving assistance with various operations through advanced driver-assistance systems (ADAS) and the like. There are various kinds of driving assistance, and contents of the driving assistance to be executed are generally conveyed to the driver via a display device, such as a monitor in the vehicle.

Japanese Unexamined Patent Application Publication No. 2022-139186 (JP 2022-139186 A) describes displaying behavior information that indicates a temporal behavior of a vehicle on a display device, based on operation history information of driving assistance by a driving assistance system and driving history information of the vehicle.

### SUMMARY

Meanwhile, various kinds of driving assistance are known. Specifically, there are deceleration assistance for helping solely with a deceleration operation in a case where a predetermined condition is satisfied, adaptive cruise control (ACC) that includes an acceleration and deceleration operation and the like for following a preceding vehicle while maintaining a predetermined inter-vehicle distance, and the like. Here, the deceleration assistance mentioned above and the ACC have different ranges of assistance. On the other hand, the deceleration assistance mentioned above and the deceleration assistance to be executed during operation of the ACC, while differences in detailed conditions and the like are present therebetween, are assistance operations recognized by the driver as substantially the same control behavior. Therefore, when displaying the functions, it is advisable to inform an occupant of the vehicle, particularly the driver, of the functions including assistance contents, in an easily understandable manner at a glance, in order to prevent the driver from misunderstanding the assistance contents, and the like.

The present disclosure can provide a display control device, a display control method, and a non-transitory computer-readable recording medium capable of informing an occupant of information related to deceleration assistance in an easily understandable manner.

A first aspect of the present disclosure relates to a display control device including a data acquisition unit and a display controller. The data acquisition unit is configured to acquire mode information including a driving assistance mode of a vehicle and information related to deceleration assistance for decelerating the vehicle. The display controller is configured to display a driving mode image corresponding to the acquired mode information on a display device and to specify a display format of a deceleration assistance image to be displayed in relation to the deceleration assistance in a corresponding manner to a display format of the driving mode image and display the deceleration assistance image in the specified display format on the display device.

In the display control device according to the aspect, since the display format of the deceleration assistance image corresponds to the display format of the driving mode image, the driving assistance mode in operation can also be understood simply by viewing the deceleration assistance image.

In the display control device according to the aspect, the display format of the deceleration assistance image may include at least one of a color of the deceleration assistance image, a thickness of a line in the deceleration assistance image, or a size of the deceleration assistance image.

In the display control device according to the aspect, since the deceleration assistance image itself is not changed, there is no need to prepare a plurality of kinds of deceleration assistance images in accordance with the driving assistance mode in operation.

In the display control device according to the aspect, the driving assistance mode may include a deceleration assistance mode for solely performing deceleration assistance and an adaptive cruise control mode including acceleration and deceleration assistance for following a preceding vehicle at a constant interval.

In the display control device according to the aspect, deceleration assistance images representing the deceleration assistance in different modes can be distinguished at a glance.

In the display control device according to the aspect, the driving assistance mode may further include a congestion following mode including acceleration and deceleration assistance for following the preceding vehicle at a constant interval when congestion has occurred.

In the display control device according to the aspect, deceleration assistance images representing the deceleration assistance in different modes can be distinguished at a glance.

In the display control device according to the aspect, the deceleration assistance image may be an icon representing an event where the deceleration assistance is needed.

In the display control device according to the aspect, employing the icon as the image makes it easier for the user to immediately understand the meaning of the image.

A second aspect of the present disclosure relates to a display control method. The display control method includes displaying a driving mode image corresponding to a driving assistance mode of a vehicle on a display device provided in the vehicle, adjusting a display format of a deceleration assistance image to a display format corresponding to a display format of the driving mode image when executing deceleration assistance, and displaying the deceleration assistance image in the adjusted display format together with the driving mode image.

In the display control method according to the aspect, since the display format of the deceleration assistance image is adjusted to correspond to the display format of the driving mode image and then displayed, the driving assistance mode in operation can also be understood simply by viewing the deceleration assistance image.

A third aspect of the present disclosure relates to a non-transitory computer-readable recording medium. The non-transitory computer-readable recording medium storing a code that causes a processor constituting a computer to execute displaying a driving mode image corresponding to a driving assistance mode of a vehicle on a display device provided in the vehicle, adjusting a display format of a deceleration assistance image to a display format corresponding to a display format of the driving mode image when executing deceleration assistance, and displaying the deceleration assistance image in the adjusted display format together with the driving mode image.

In the non-transitory computer-readable recording medium according to the aspect, since the display format of the deceleration assistance image is adjusted to correspond to the display format of the driving mode image and then displayed, the driving assistance mode in operation can also be understood simply by viewing the deceleration assistance image.

With the display control device, the display control method, and the non-transitory computer-readable recording medium of the present disclosure, an occupant can be informed of information related to deceleration assistance in an easily understandable manner.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic block diagram showing an example of a display control device according to an embodiment of the present disclosure;

FIG. 2 is a functional block diagram showing an example of a software configuration of the display control device shown in FIG. 1;

FIG. 3A is a diagram showing an example of deceleration assistance image;

FIG. 3B is a diagram showing an example of deceleration assistance image;

FIG. 3C is a diagram showing an example of deceleration assistance image;

FIG. 3D is a diagram showing an example of deceleration assistance image;

FIG. 3E is a diagram showing an example of deceleration assistance image;

FIG. 3F is a diagram showing an example of deceleration assistance image;

FIG. 3G is a diagram showing an example of deceleration assistance image;

FIG. 3H is a diagram showing an example of deceleration assistance image;

FIG. 4 is a diagram showing an example of a display image in a deceleration assistance mode;

FIG. 5 is a diagram showing an example of a display image in an ACC mode;

FIG. 6 is a diagram showing an example of a display image in a congestion following mode; and

FIG. 7 is a flowchart showing an example of a display control method according to the embodiment of the present disclosure.

### DETAILED DESCRIPTION OF EMBODIMENTS

Hereinafter, each embodiment for implementing the present disclosure will be described with reference to the drawings. Hereinafter, a range needed for description to achieve the object of the present disclosure will be schematically shown, a range needed for description of the corresponding portion of the present disclosure will be mainly described, and any portions where descriptions are omitted will be based on known technologies. Additionally, identical or corresponding members in the figures are assigned the same or similar reference numerals, and duplicate descriptions thereof will be omitted. Further, in a case where a plurality of identical or corresponding members in the figures is included, solely some of the members may be assigned reference numerals in order to make the figure easier to understand.

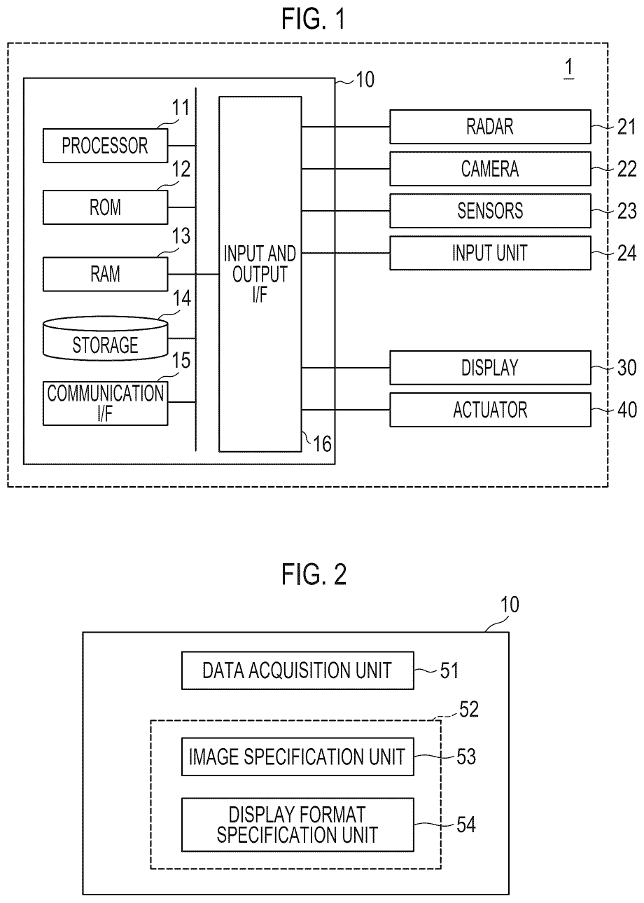

FIG. 1 is a schematic block diagram showing an example of a display control device according to an embodiment of the present disclosure. A display control device 10 according to the present embodiment is mounted in a vehicle 1 and used. In addition, the display control device 10 can be configured as a part of a driving assistance electronic control unit (ECU) that constitutes a driving assistance system represented by ADAS.

The display control device 10 can be configured with a computer including a microcontroller or the like. The computer may include a processor 11, a read only memory (ROM) 12 and a random access memory (RAM) 13 as examples of a memory, a storage 14, a communication interface 15, and an input and output interface 16. Additionally, the configurations may be communicably connected to each other via an internal bus.

The processor 11 may be configured with, for example, a central processing unit (CPU), and may execute various programs or control each unit. Specifically, the processor 11 may read various programs stored in the ROM 12 or the storage 14 and execute the programs using the RAM 13 as a work area. The processor 11 may control each component constituting the display control device 10 or perform various arithmetic processes in accordance with the programs.

The ROM 12 may store various programs and various kinds of data.

Additionally, the RAM 13 may temporarily store programs or data as a work area.

The storage 14 can be configured with a recording medium, such as a hard disk drive (HDD), a solid state drive (SSD), or a flash memory, and may store various programs including an operating system and various kinds of data needed to operate the display control device 10. In the present embodiment, the ROM 12 or the storage 14 may store programs or various kinds of data for displaying desired information on a display 30. In addition, the storage 14 can also store map data used for the ACC.

Further, the storage 14 according to the present embodiment may store data related to a driving mode image 71 to be displayed on the display 30 as an example of the display device in accordance with the driving assistance mode. As the driving assistance mode described herein, at least a deceleration assistance mode for solely performing the deceleration assistance, and an adaptive cruise control (ACC) mode including acceleration and deceleration assistance for following a preceding vehicle at a constant interval may be included. In the present embodiment, in addition to the two modes described above, a case will be described as an example in which a congestion following mode that is selected when congestion has occurred and that includes acceleration and deceleration assistance for following the preceding vehicle at a constant interval (for example, hands-off) is further included. Additionally, the storage 14 may store data related to a deceleration assistance image 61 to be displayed on the display 30 when the deceleration assistance is executed. The deceleration assistance image of the present embodiment can be configured as, for example, an icon (or a mark) representing an event where the deceleration assistance is needed. Specific examples of the driving mode image 71 and the deceleration assistance image 61 will be described below.

The communication interface (I/F) 15 may be a wireless communication-capable interface for the display control device 10 to communicate with a server computer, various databases, a terminal device of a user (for example, an occupant of the vehicle 1), or the like (not shown) via a network or the like. In the communication interface 15, communication standards, such as a controller area network (CAN), Ethernet (registered trademark), long term evolution (LTE), a fiber distributed data interface (FDDI), or Wi-Fi (registered trademark), may be used.

The input and output interface (I/F) 16 may be an interface for transmitting and receiving data or the like mainly between various components mounted in the vehicle 1 or the like that are needed for display control. The components electrically connected to the input and output interface 16 may be appropriately selected. As shown in FIG. 1, the input and output interface 16 of the present embodiment can acquire desired data from, for example, a radar 21, a camera 22, sensors 23, and an input unit 24. In addition, the input and output interface 16 of the present embodiment can output specific data to the display 30 and an actuator 40. The component from which the input and output interface 16 acquires the data can be various components related to the driving assistance and is not limited to the components described above. Further, the component to which the input and output interface 16 outputs the data is not limited to the components described above.

The radar 21 may be a radar for specifying a three-dimensional object present around the vehicle 1. Specifically, for example, the radar 21 includes a transmitter and a receiver, and emits millimeter-wave radio waves (hereinafter, simply referred to as “millimeter waves”) from the transmitter to the surroundings of the vehicle 1 and receives reflected waves thereof through the receiver. Then, the three-dimensional object within a range in which the millimeter waves are emitted is specified from a time when the reflected waves are received, a degree of attenuation, and the like. A specification result by the radar 21 is transmitted to the display control device 10.

The camera 22 may be an imaging device capable of capturing an image mainly in front of the vehicle 1. The camera 22 can be configured with, for example, a two-dimensional camera including a well-known image sensor, such as a charge coupled device (CCD) or a complementary metal oxide semiconductor (CMOS) image sensor. The image captured by the camera 22 is transmitted to the display control device 10.

The sensors 23 may include various sensors and the like mounted on the vehicle 1. Specifically, a vehicle speed sensor, an acceleration sensor, an accelerator pedal sensor, a brake pedal sensor, a steering angle sensor, a shift lever sensor, an ultrasonic sensor, and the like may be included. In addition, a positioning device represented by a global positioning system (GPS), or the like may be further provided. Results detected by the sensors 23 are transmitted to the display control device 10.

The input unit 24 is capable of accepting an input operation from the user. The input unit 24 may include various switches, a touch panel, a lever, and the like installed in a vehicle cabin. Additionally, the input unit 24 of the present embodiment includes a switch capable of switching the driving assistance mode. The content input via the input unit 24 is transmitted to the display control device 10.

The display 30 is a device for displaying information transmitted from the display control device 10. The display 30 can be configured with a well-known display, such as a liquid crystal display (LCD) or an organic electro-luminescent display (OELD). In addition, the display 30 may include a display driver (not shown). The display 30 need only be disposed at a position visible from the driver's seat in the vehicle cabin and may be disposed at any position, such as in front of the driver's seat or in the center of the front of the vehicle cabin.

The actuator 40 is a device that operates to control the vehicle 1, for example, for driving assistance. The actuator 40 may include at least an actuator of a drive system, such as an engine, and an actuator of a brake system, such as a braking device. The kinds of the actuator are not limited to the actuators described above and may include various kinds of actuators, such as an actuator of a steering system.

FIG. 2 is a functional block diagram showing an example of a software configuration of the display control device shown in FIG. 1. As shown in FIG. 2, the display control device 10 of the present embodiment includes a data acquisition unit 51 that acquires mode information including the driving assistance mode of the vehicle 1 and information related to deceleration assistance for decelerating the vehicle 1, and a display controller 52 that displays the driving mode image 71 corresponding to the acquired mode information on the display 30 and that specifies a display format of the deceleration assistance image 61 to be displayed in relation to the deceleration assistance in a corresponding manner to a display format of the driving mode image 71 and displays the deceleration assistance image 61 in the specified display format on the display 30.

The data acquisition unit 51 can be implemented mainly by the input and output interface 16 and has at least a function of acquiring the mode information and the information related to the deceleration assistance. As described above, the mode information includes information regarding any of the deceleration assistance mode, the ACC mode, or the congestion following mode. The ACC mode in the present embodiment can be a map-linked ACC mode that implements driving assistance linked with map information based on the map data stored in the storage 14 and a positioning result of the positioning device. In addition, the information regarding the deceleration assistance includes, for example, information regarding a situation where the deceleration assistance is needed, which can be acquired during traveling. The information regarding the deceleration assistance may be specified based on a road sign imaged by the camera 22, route information that can be specified by referring to the map information, or the like.

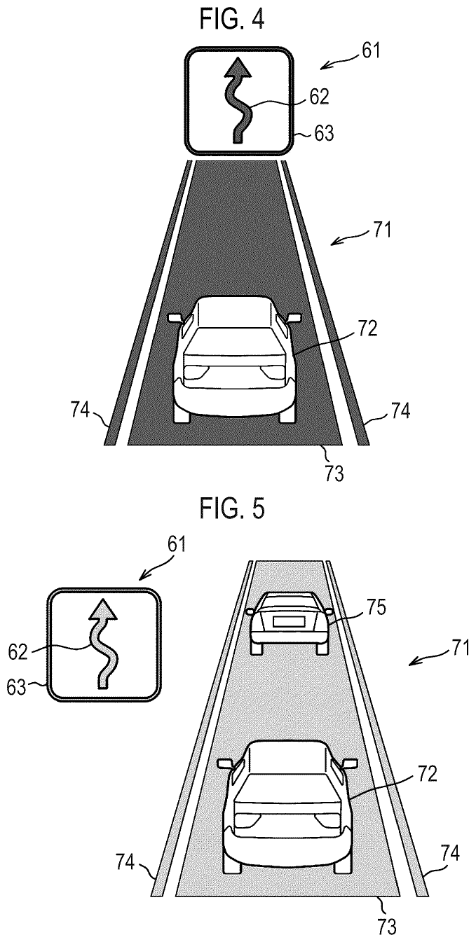

The display controller 52 can be implemented mainly by the processor 11 and has a function of controlling a display content to be displayed on the display 30. The display controller 52 may include an image specification unit 53 that specifies an image to be displayed on the display 30 and a display format specification unit 54 that specifies a display format of an image, particularly the deceleration assistance image 61 (refer to FIG. 4 and the like).

The image specification unit 53 has a function of specifying the driving mode image 71 (refer to FIG. 4 and the like) that matches the selected driving assistance mode for display on the display 30, from the mode information acquired by the data acquisition unit 51. Additionally, the image specification unit 53 also has a function of specifying the deceleration assistance image 61 to be displayed on the display 30 from the information regarding the deceleration assistance acquired by the data acquisition unit 51.

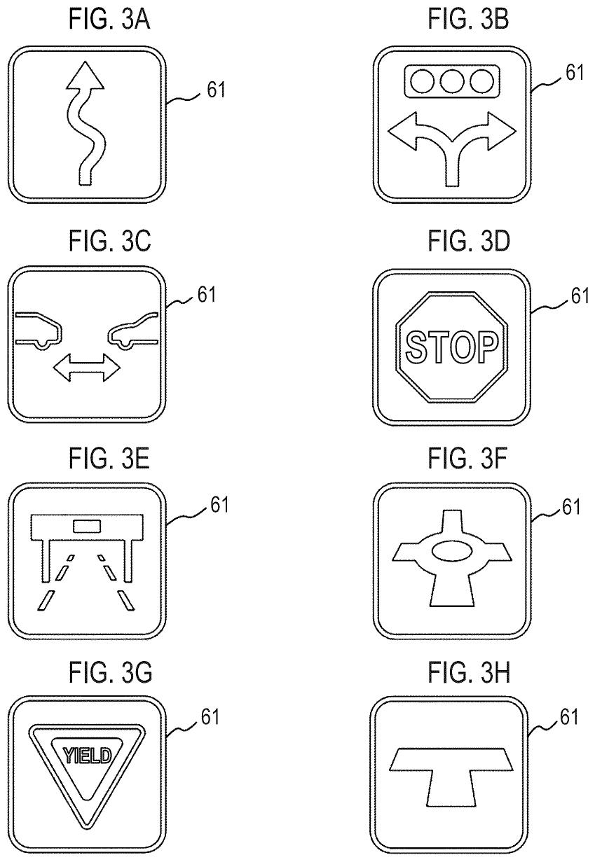

FIGS. 3A to 3H are diagrams showing examples of the deceleration assistance images. As the deceleration assistance image 61 specified by the image specification unit 53, an icon image that schematizes an event that is encountered while the vehicle 1 is traveling and the deceleration assistance is needed, may be included. Specifically, the images as illustrated in FIGS. 3A to 3H can be included. That is, examples of the images can include a deceleration assistance image 61 showing a curve (refer to FIG. 3A), a deceleration assistance image 61 showing a signal lane (refer to FIG. 3B), a deceleration assistance image 61 showing that it is getting closer to the preceding vehicle (refer to FIG. 3C), a deceleration assistance image 61 showing a temporary stop (refer to FIG. 3D), a deceleration assistance image 61 showing a tollgate (refer to FIG. 3E), a deceleration assistance image 61 showing a roundabout (circular intersection) (refer to FIG. 3F), a deceleration assistance image 61 showing a yield (YIELD) (refer to FIG. 3G), and a deceleration assistance image 61 showing a T-junction (refer to FIG. 3H). In this manner, when the icon image that schematizes the above-described event (the curve, the signal lane, or the like described above) where the deceleration assistance is needed is employed as the deceleration assistance image 61, the user can infer the event at a glance, which is preferable. The deceleration assistance image 61 is not limited to the images described above as long as the image is related to the event where the deceleration assistance is needed. In addition, among the deceleration assistance images 61, the deceleration assistance image 61 showing a temporary stop, the deceleration assistance image 61 showing a tollgate, the deceleration assistance image 61 showing a roundabout (circular intersection), the deceleration assistance image 61 showing a yield (YIELD), or the deceleration assistance image 61 showing a T-junction corresponds to a landmark that can be recognized in advance in the map-linked ACC mode.

Meanwhile, even in a case where the event where the deceleration assistance is needed is the same, the control behavior (for example, a trigger for starting the deceleration assistance) may be strictly different when the driving assistance mode of the vehicle 1 is different. In such a case, when the same image is displayed as the deceleration assistance image 61 to be displayed on the display 30 regardless of the driving assistance mode, the driver who views the image cannot specify at a glance in which the driving assistance mode the deceleration assistance is operating. Therefore, even when the same deceleration assistance image 61 is displayed, differences in the control behavior may occur, and the driver may feel uncomfortable with the behavior of the vehicle 1. The display control device 10 according to the present embodiment, taking into consideration the points described above, provides the deceleration assistance image 61 to which the information regarding the driving assistance mode in operation is also added while employing an image that is easily understandable at a glance by the user, thereby eliminating the discomfort that the driver may feel.

In consideration of the points described above, the display controller 52 of the display control device 10 according to the present embodiment includes the display format specification unit 54 as described above. The display format specification unit 54 functions to specify the display format of the image to be displayed on the display 30, particularly the deceleration assistance image 61. Here, the display format may include at least one of a color of the deceleration assistance image 61, a thickness of a line in the deceleration assistance image 61, or a size of the deceleration assistance image 61. In the following description, an example will be described in which the display format specification unit 54 specifies the color of the deceleration assistance image 61.

A display image to be displayed on the display 30 by the display controller 52 will be described below with reference to FIGS. 4 to 6.

FIG. 4 is a diagram showing an example of a display image in the deceleration assistance mode. The display 30 of the vehicle 1 during the deceleration assistance mode may display the driving mode image 71, or the driving mode image 71 and the deceleration assistance image 61. As shown in FIG. 4, the driving mode image 71 may include, for example, a host vehicle image 72 corresponding to the vehicle 1, a traveling lane image 73 corresponding to a traveling lane in which the vehicle 1 is traveling, and a white line image 74 corresponding to white lines representing a centerline, shoulder lines, and the like extending along the traveling lane, and the like. In addition, the deceleration assistance image 61 can be configured, for example, as an icon indicating that the traveling lane on the route is curved. In the display image shown in FIG. 4, the deceleration assistance image 61 is disposed to be continuous with an end portion of the traveling lane image 73 in the driving mode image 71, but the position of the deceleration assistance image 61 can be appropriately changed.

Meanwhile, the driving mode image 71 is displayed in a state in which each part is colored in any color. Specifically, the driving mode image 71 in the display image displayed during the deceleration assistance mode is displayed with a traveling lane image 73 portion, or the traveling lane image 73 portion and a white line image 74 portion, colored in any color, for example in gray, as shown in FIG. 4. In the display control device 10 according to the present embodiment, the display format specification unit 54 specifies the color of the deceleration assistance image 61 displayed together with the driving mode image 71 to a color corresponding to the color of the driving mode image 71, that is, gray. When the color to be colored is specified, the deceleration assistance image 61 is displayed on the display 30 together with the driving mode image 71 after any region in the deceleration assistance image 61, for example, an icon portion 62 and a frame portion 63 surrounding the icon portion 62, is colored gray. In the present embodiment, an example has been described in which the icon portion 62 of the deceleration assistance image 61 and the frame portion 63 surrounding the icon portion 62 are colored gray, but portions to be colored are not limited thereto. For example, a region inside the frame portion 63 excluding the icon portion 62 can be colored, or solely either the icon portion 62 or the frame portion 63 can be colored. Additionally, the color of the deceleration assistance image 61 need only correspond to the color of the driving mode image 71, and the color may be different in shade or the like.

The user who views the display image shown in FIG. 4, particularly the driver, can immediately understand from the deceleration assistance image 61 displayed in the display format corresponding to the driving mode image 71 that the deceleration assistance due to the curve on the route is executed in the deceleration assistance mode.

FIG. 5 is a diagram showing an example of a display image in the ACC mode. The driving mode image 71, or the driving mode image 71 and the deceleration assistance image 61 may be displayed on the display 30 of the vehicle 1 during the ACC mode. As shown in FIG. 5, the driving mode image 71 may include, for example, the host vehicle image 72, the traveling lane image 73, the white line image 74, and a preceding vehicle image 75 showing a preceding vehicle that is traveling in front of the vehicle 1 and that is a target of following traveling. In addition, the deceleration assistance image 61 can be configured, for example, as an icon indicating a curve, as in FIG. 4. In FIG. 5, an example is shown in which the deceleration assistance image 61 is disposed on the side of the driving mode image 71. Further, the host vehicle image 72 and the preceding vehicle image 75 may be colored in any color.

The driving mode image 71 in the display image displayed during the ACC mode is displayed with the traveling lane image 73 portion, or the traveling lane image 73 portion and the white line image 74 portion, colored in any color different from the driving mode image 71, for example in green, as shown in FIG. 5. In this manner, changing the color used for the display image for each mode is effective in quickly conveying the current mode to the user who views the display image. In the display control device 10 according to the present embodiment, the display format specification unit 54 specifies the color of the deceleration assistance image 61 displayed together with the driving mode image 71 to the color corresponding to the color of the driving mode image 71, that is, green. When the color to be colored is specified, the deceleration assistance image 61 is displayed on the display 30 together with the driving mode image 71 after any region in the deceleration assistance image 61, for example, the icon portion 62 and the frame portion 63 surrounding the icon portion 62, is colored green.

The user who views the display image shown in FIG. 5, particularly the driver, can immediately understand from the deceleration assistance image 61 displayed in the display format corresponding to the driving mode image 71 that the deceleration assistance due to the curve on the route is executed in the ACC mode.

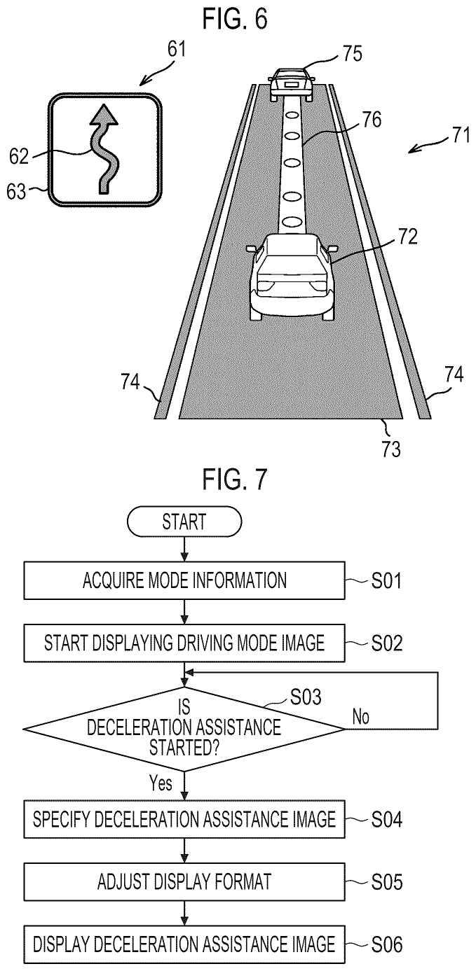

FIG. 6 is a diagram showing an example of a display image in the congestion following mode. The driving mode image 71, or the driving mode image 71 and the deceleration assistance image 61 may be displayed on the display 30 of the vehicle 1 during the congestion following mode. As shown in FIG. 6, the driving mode image 71 may include, for example, the host vehicle image 72, the traveling lane image 73, the white line image 74, the preceding vehicle image 75, and a predicted traveling trajectory image 76 that connects the host vehicle image 72 and the preceding vehicle image 75 and that shows a predicted traveling trajectory of a host vehicle. In addition, the deceleration assistance image 61 may be configured, for example, as an icon indicating a curve and may be disposed on the side of the driving mode image 71, as in FIG. 5.

The driving mode image 71 in the display image displayed during the congestion following mode is displayed with the traveling lane image 73 portion, or the traveling lane image 73 portion and the white line image 74 portion, colored in any color different from the driving mode image 71, for example in blue, as shown in FIG. 6. In the display control device 10 according to the present embodiment, the display format specification unit 54 specifies the color of the deceleration assistance image 61 displayed together with the driving mode image 71 to the color corresponding to the color of the driving mode image 71, that is, blue. When the color to be colored is specified, the deceleration assistance image 61 is displayed together with the driving mode image 71 after any region in the deceleration assistance image 61, for example, the icon portion 62 and the frame portion 63 surrounding the icon portion 62, is colored blue.

The user who views the display image shown in FIG. 6, particularly the driver, can immediately understand from the deceleration assistance image 61 displayed in the display format corresponding to the driving mode image 71 that the deceleration assistance due to the curve on the route is executed in the congestion following mode.

As described above, with the display control device 10 according to the present embodiment, the format corresponding to the display format of the selected driving assistance mode is employed as the display format of the deceleration assistance image 61 to be displayed on the display 30. In other words, with the display control device 10 according to the present embodiment, the information on the driving assistance mode in operation is added to the deceleration assistance image by changing solely the display format without changing the shape of the icon or the like displayed as the deceleration assistance image. As a result, the user who views the image displayed on the display 30 can immediately and accurately understand both the selected driving assistance mode and the content of the deceleration assistance.

Next, a display control method according to the present embodiment will be described. Hereinafter, a case where the display control method according to the present embodiment is implemented in the vehicle 1 including the display control device 10 will be described as an example. Additionally, the display control method to be described below may be implemented by executing a program for causing at least one processor 11 of the computer constituting the display control device 10 to execute a predetermined operation. The program may be stored in a storage unit, such as the ROM 12 or the storage 14, or may be provided in the form of a non-transitory computer-readable recording medium.

The display control method according to the present embodiment includes at least a step of displaying the driving mode image 71 corresponding to the driving assistance mode of the vehicle 1 on the display 30 provided in the vehicle 1 (corresponding to step S02 to be described below), a step of adjusting the display format of the deceleration assistance image 61 to the display format corresponding to the display format of the driving mode image 71 when executing the deceleration assistance (corresponding to step S05 to be described below), and a step of displaying the adjusted deceleration assistance image 61 together with the driving mode image 71 (corresponding to step S06 to be described below). Hereinafter, specific examples will be described.

FIG. 7 is a flowchart showing an example of the display control method according to the embodiment of the present disclosure. The display control method according to the present embodiment is started when the power of the vehicle 1 is turned on and the user performs a selection operation of the driving assistance mode via the input unit 24. When a predetermined driving assistance mode is selected by the user, the display control device 10 acquires the mode information through the data acquisition unit 51 (step S01). Next, the display controller 52 specifies the driving mode image 71 that matches the acquired mode information such that the user can understand the driving assistance mode in operation, and starts displaying the driving mode image 71 on the display 30 (step S02).

After the display of the driving mode image is started, when an event where the deceleration assistance is needed, for example, the presence of the curve ahead is detected by the camera 22 of the vehicle 1 (Yes in step S03), the display process of the deceleration assistance image 61 is started. Specifically, first, the display controller 52 specifies the deceleration assistance image 61 corresponding to the detected event where the deceleration assistance is needed (step S04). Next, the display controller 52 adjusts the specified display format of the deceleration assistance image 61 in accordance with the display format of the driving mode image 71 that is already displayed on the display 30 (step S05). In the present embodiment, the display format is adjusted by adjusting the color of the deceleration assistance image 61 to be the same as the color of the driving mode image 71. Then, the display controller 52 displays the deceleration assistance image 61 after the display format is adjusted, on the display 30, together with the driving mode image 71 (step S06). Through the above processes, the display controller 52 completes the display of the deceleration assistance image 61. The displayed deceleration assistance image 61 is terminated when the event where the deceleration assistance is needed is resolved (for example, when the curve has been passed). In addition, when the driving assistance mode is changed, the display content of the driving mode image 71 is switched.

As described above, in the display control method and the program according to the present embodiment, the display format of the deceleration assistance image is also adjusted to be the same as the display format of the driving mode image 71 being displayed on the display 30. Therefore, both the event that causes the deceleration assistance and the driving assistance mode that the deceleration assistance is based on can be immediately and accurately conveyed to the user.

In addition, in each embodiment, the processor 11 indicates a processor in a broad sense and includes a general-purpose processor or a dedicated processor (for example, a graphics processing unit (GPU), an application specific integrated circuit (ASIC), a field programmable gate array (FPGA), a programmable logic device, or the like).

Further, the operation of the processor in each embodiment may be performed not solely by one processor but also by a plurality of processors present at physically separated positions and cooperating with each other. Additionally, the order of each operation of the processor is not limited to the order described in each embodiment and may be appropriately changed.

The present disclosure is not limited to the embodiment and can be implemented through various modifications within the scope of the present disclosure. All of these are included in the technical idea of the present disclosure. Moreover, unless otherwise specified in the specification, each of the components of the present disclosure is not limited to one, and a plurality of the components may be present.

What is claimed is:

1. A display control device comprising:
a data acquisition unit configured to acquire mode information including a driving assistance mode of a vehicle and information related to deceleration assistance for decelerating the vehicle; and
a display controller configured to display a driving mode image corresponding to the acquired mode information on a display device and to specify a display format of a deceleration assistance image to be displayed in relation to the deceleration assistance in a corresponding manner to a display format of the driving mode image and display the deceleration assistance image in the specified display format on the display device.

2. The display control device according to claim 1, wherein the display format of the deceleration assistance image includes at least one of a color of the deceleration assistance image, a thickness of a line in the deceleration assistance image, or a size of the deceleration assistance image.

3. The display control device according to claim 1, wherein the driving assistance mode includes a deceleration assistance mode for solely performing deceleration assistance and an adaptive cruise control mode including acceleration and deceleration assistance for following a preceding vehicle at a constant interval.

4. The display control device according to claim 3, wherein the driving assistance mode further includes a congestion following mode including acceleration and deceleration assistance for following the preceding vehicle at a constant interval when congestion has occurred.

5. The display control device according to claim 1, wherein the deceleration assistance image is an icon representing an event where the deceleration assistance is needed.

6. A display control method comprising:
displaying a driving mode image corresponding to a driving assistance mode of a vehicle on a display device provided in the vehicle;
adjusting a display format of a deceleration assistance image to a display format corresponding to a display format of the driving mode image when executing deceleration assistance; and
displaying the deceleration assistance image in the adjusted display format together with the driving mode image.

7. A non-transitory computer-readable recording medium storing a code that causes a processor constituting a computer to execute:
displaying a driving mode image corresponding to a driving assistance mode of a vehicle on a display device provided in the vehicle;
adjusting a display format of a deceleration assistance image to a display format corresponding to a display format of the driving mode image when executing deceleration assistance; and
displaying the deceleration assistance image in the adjusted display format together with the driving mode image.
